(19) United States
(12) Patent Application Publication
(10) Pub. No.: US 2012/0081392 A1
(43) Pub. Date: Apr. 5, 2012

(54) ELECTRONIC DEVICE OPERATION ADJUSTMENT BASED ON FACE DETECTION

(75) Inventor: John E. Arthur, Santa Clara, CA (US)

(73) Assignee: APPLE INC., Cupertino, CA (US)

(21) Appl. No.: 12/894,534

(22) Filed: Sep. 30, 2010

(51) Int. Cl. G09G 5/00

(52) U.S. Cl. 345/633

(57) ABSTRACT

An electronic device and methods of use thereof are described. The electronic device having at least a front facing image capture device and a front facing display device arranged to display visual content is described. In one embodiment, the front facing camera can capture an image that can include at least image content. The image content can process in such a way that an operational state of the electronic device is modified in accordance with processed image content. In a particular embodiment, the modification of the current operating state can include aligning an orientation of visual content presented by the front facing display with a current facial orientation of a user.

### TECHNICAL FIELD

The embodiments described herein relate generally to the field of electronic devices. More particularly, the embodiments describe techniques for using content of an image captured by a camera associated with the electronic device to modify a current operating state of the electronic device.

### BACKGROUND

Electronic devices can include an image capture system such as a camera. The camera can be configured to capture both still images such as a snap shot or moving images that can be processed to form video. Recently, it has become popular to reduce the size and weight of the electronic devices such that they become highly portable in nature. In this way, the highly portable electronic devices can include a front facing camera configured to capture images. However, most of the information associated with the captured images is generally not used since only a small fraction of the total image data captured is retained. Therefore, most camera systems associated with small form factor electronic devices have a very low average utilization factor for the resources, both hardware and computational, dedicated to the camera system. This wasteful use of resources is particularly problematic in highly portable small form factor electronic devices where available space is limited.

Therefore, an electronic device that practices an efficient method, system, and apparatus of a multipurpose image capture system is desired.

### SUMMARY OF THE DESCRIBED EMBODIMENTS

A method for displaying visual content by an electronic device having a plurality of operational components at least one of which is a front facing image capture device and at least another is a front facing display device arranged to display visual content is described. The method can be carried out by capturing an image by the front facing image capture device, the image including image content, determining an orientation of a human face associated with at least some of the captured image content, and aligning the orientation of at least some of the visual content presented at the display in real time in accordance with the orientation of the human face.

In one embodiment, electronic device includes a rear facing camera arranged to capture a rear facing image. The rear facing image can be presented as at least some of the visual content presented at the display in real time in accordance with the orientation of the human face.

In yet other embodiments, at least some of the visual content can be presented aligned with the direction of gravity independent of the orientation of the electronic device. In other embodiments, a preferred orientation can be used to process captured images in accordance with the preferred orientation.

A personal media device includes at least a front facing display configured to present visual content, a front facing camera, the front facing camera configured to capture image data, a facial orientation module, the facial orientation module arranged to generate a facial orientation vector based in part upon the captured image data, the facial orientation vector corresponding to a facial orientation of a current user viewing the front facing display, a rear facing image capture device arranged to capture a rear facing image, and a processor coupled to the front facing display, the front facing camera, and the rear facing camera, the processor configured to display in real time at least some of the visual content presented by the display in accordance with the orientation of the human face.

Non-transitory computer readable medium for storing computer code executed by a processor in a personal media device having at least a front facing image capture device and a front facing display device arranged to display visual content for modifying a current operational state of the personal media player. The computer readable medium includes at least computer code for capturing an image by the image capture device, the image including image content and computer code for modifying the current operational state of the electronic device in accordance with captured image content.

A method can be performed by capturing image data by a front facing image capture device associated with a personal media device, the personal media device having a front facing display configured for displaying visual content at an orientation, presenting the visual content at the display device at the orientation, determining if a human face is included in the captured image data, determining a facial orientation vector associated with the human face, and using the facial orientation vector to modify the presenting of the visual content by the display.

Other apparatuses, methods, features and advantages of the described embodiments will be or will become apparent to one with skill in the art upon examination of the following figures and detailed description. It is target that all such additional apparatuses, methods, features and advantages be included within this description be within the scope of and protected by the accompanying claims.

### BRIEF DESCRIPTION OF THE DRAWINGS

The described embodiments and the advantages thereof can best be understood by reference to the following description taken in conjunction with the accompanying drawings.

FIGS. 1A and 1B show a representation of a personal media device (PMD) according to one embodiment.

FIG. 2 illustrates a block diagram of an embodiment of the personal media device shown in FIG. 1.

FIG. 3 is a graphical representation for determining a facial orientation vector of a user by PMD in accordance with the described embodiments.

FIGS. 4-8 graphically illustrate the operation of PMD in a facial orientation mode in accordance with the described embodiments.

FIGS. 9A and 9B, and 10-12 show flowcharts detailing processes in accordance with the described embodiments

FIGS. 13-14 show representative portable media device in accordance with the described embodiments.

### DETAILED DESCRIPTION OF REPRESENTATIVE EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

Aspects of the described embodiments relate to operation of an electronic device. In particular, the electronic device can include an image capture device that is capable of capturing images. In a particular embodiment, the image capture device can be a front facing image capture device. In this way, when the electronic device is portable and held by a user, the front facing image capture device can capture image data at least some of which is associated with the user. The images can take the form of still images such as a snap shot, or moving images that can be processed into video of any format. In one embodiment, the image capture device can operate in what can be referred to as a background operation mode by which it is meant that the image capture device can initiate an image capture process as part of the background operations carried out by the operating system of the electronic device. In this way, the image capture device can receive information in the form of image data without direct action by or knowledge of a user.

In some embodiments, captured image data can be used to control or at least influence operations of the electronic device. For example, when the electronic device can capture images of a human face, motions of the human face (nodding, shaking side to side, facial expressions) can be used to modify operations of the electronic device.

In a particularly useful embodiment, image data received at the image capture device can be processed in such as way as to alter a current operating state of the electronic device. In those embodiments where the electronic device includes a front facing display for presenting visual content, the manner in which the visual content is presented can be altered by the image data received at the image capture device and processed by the electronic device. The presentation of the visual content can be altered in any number of ways. For example, an orientation (i.e., landscape or portrait) of the presented visual content can be altered based upon image data received at the image capture and processed by the electronic device. This is particularly advantageous when the captured image data includes image data corresponding to a human face associated a user of the electronic device. By utilizing well known facial recognition techniques, the electronic device can process that portion of the captured image data determined to correspond to the human face. In one aspect, the facial data can be used to determine an orientation of the human face relative to the orientation of the presented visual content. In other words, the electronic device can determine if the orientation of the presented visual content is substantially the same, or different, than the orientation of the human face. In one implementation, the electronic device can alter the current orientation of the presented visual content to more closely align with that of the human face.

It should be noted that the orienting feature of the described embodiments is independent of any inertial or gravimetric techniques used in the prior art to ascertain the orientation of the user. Typical accelerometer or other inertial or gravitational based sensors rely solely upon the sensed orientation with respect to the direction of gravity of the electronic device and not the user. Accordingly, the prior art orientation sensing techniques merely presume the actual orientation of the user and not as with the techniques of the described embodiments, the actual orientation of the user. Furthermore, the orienting feature can operate in real time such that the orientation of the presented visual content can track any changes, in real time, of the user of the electronic device. For example, if a user wishes to recline and view the presented visual content, the electronic device can determine that the user is currently exhibiting a reclining orientation and adjust the orientation of the presented visual content accordingly. Therefore, unlike the prior art orienting techniques that presume the orientation of the user based solely upon the physical orientation of the electronic device, the described embodiments can use the actual orientation of the user to provide a much improved user experience.

Furthermore, the electronic device can also process the captured image data to determine if the human face is a recognized or an unrecognized human face. In this way, the electronic device can provide a layer of security based upon whether or not a current user of the electronic device is not only recognized but recognized as an approved user of the electronic device. This is particular useful in those situations where the electronic device has been lost or stolen. Any attempt to actually use the electronic device by anyone other than the owner (or other authorized user) can result in specific actions being taken designed to thwart any unauthorized use of the electronic device. As part of the facial recognition options made available by the electronic device, the electronic device can be operated in what can be referred to as a learning mode in which the electronic device can be trained to recognize a particular human face. In this way, the electronic device can learn that more than one user can be considered authorized. This ability of learning to recognize the particular human face can be a useful tool in those situations where an owner of the electronic devices desires that only a specific group of humans is authorized to operate the electronic device. Using the facial recognition feature, the authorization process can run in the background without the knowledge or nor intervention by the user of the electronic device. In this way, a seamless transition from one authorized user to another authorized user can be carried out without the need of manually inputting information such as a password, pass phrase etc.

In addition to providing orientation and security services, power saving features can also be provided. In particular, if the processing of the captured image data indicates that there it is likely that a human face is not present, and then the image capture device can continue to capture image data for processing by the electronic device. After a preset length of time with no human face detected, a presumption can be made that electronic device is currently not being used. Once it has been determined that it is likely that the electronic device is not currently being used, most components in the electronic device can be put on a standby mode in order to preserve power. In some cases, the image capture device can occasionally “wake up” to capture image data in order to determine if a user has come into view and take appropriate actions. For example, the sleeping electronic device can wake up when a recognized face that is also authorized comes into view of the image capture device. In this way, the electronic device will wake up when an authorized user comes into view and looks at the electronic device.

In the described embodiments, the electronic device can take many forms. The electronic device can, for example, take the form of a portable media device (PMD) arranged to monitor, process, present and manage image data captured by an image capture device. The PMD can pertain to a portable media device such as an iPod™, a personal communication device along the lines of the iPhone™, or portable computing platform such as a tablet computer that includes the iPad™, all of which are manufactured by Apple Inc. of Cupertino, Calif. More specifically, the image capture device can take the form of at least a front facing camera configured to capture image data that can be processed in any number of ways.

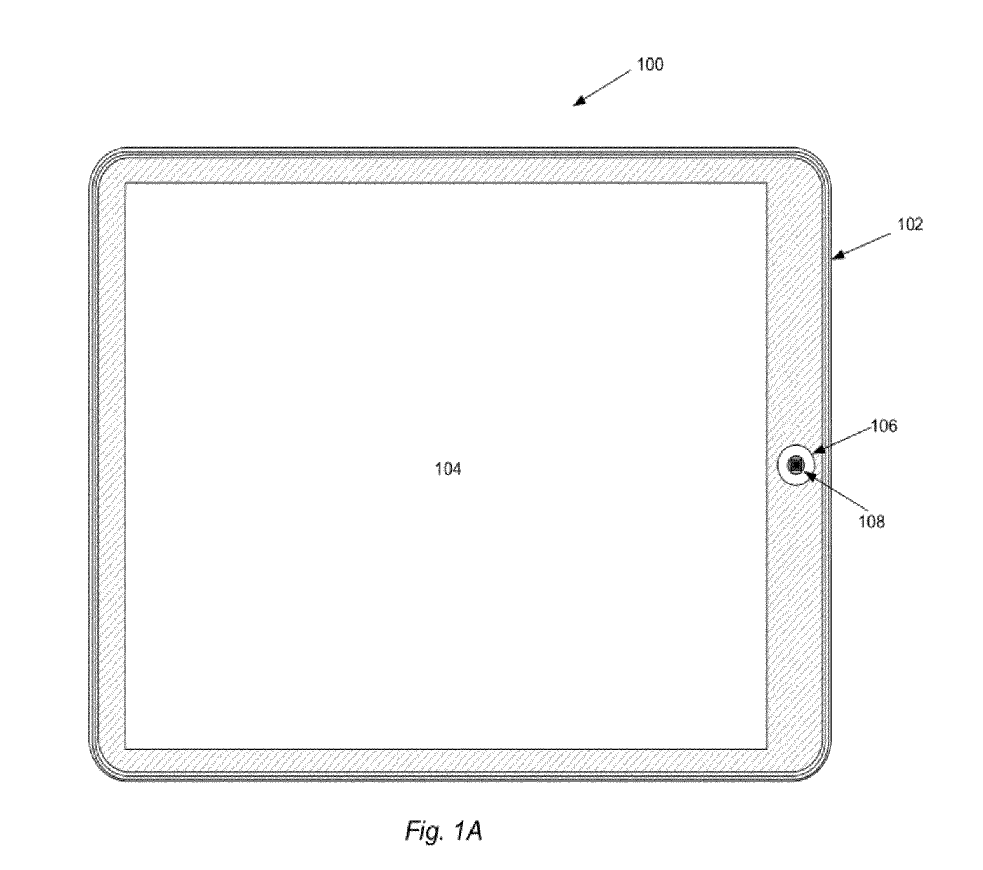

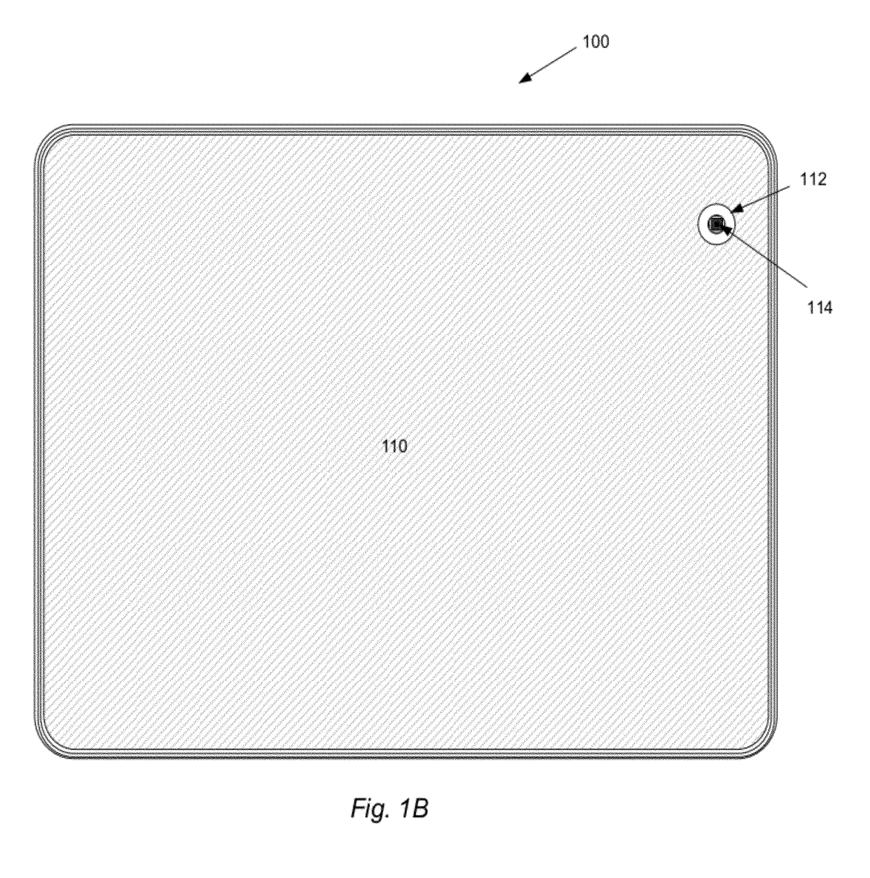

These and other embodiments are discussed below with reference to FIGS. 1-14. However, those skilled in the art will readily appreciate that the detailed description given herein with respect to these figures is for explanatory purposes only and should not be construed as limiting.

FIG. 1A shows representative portable media device (PMD) 100 in accordance with the described embodiments. PMD 100 can take many forms. PMD 100 can be, for example, a media player, a cellular phone, a personal data organizer, tablet computer, or the like. PMD 100 can include a combination of the functionalities of such devices. In addition, PMD 100 can allow a user to connect to and communicate through the Internet or through other networks, such as local or wide area networks. For example, PMD 100 can allow a user to access the internet and to communicate using e-mail, text messaging, instant messaging, or using other forms of electronic communication.

PMD 100 can be highly portable in nature and as such can be powered by one or more rechargeable and/or replaceable batteries such that PMD 100 can be carried about while traveling, working, exercising, and so forth. In this way, PMD 100 can provide services such as playing music, play games or video, record video or take pictures, place and receive telephone calls, communicate with communication devices, control other devices (e.g., via remote control and/or Bluetooth functionality), and so forth. In addition, PMD 100 can be sized such that it fits relatively easily into a pocket or a hand. While certain embodiments of the present invention are described with respect to a portable electronic device, it should be noted that the presently disclosed techniques can be applicable to a wide array of other, less portable, electronic devices and systems that are configured to render graphical data, such as a desktop computer.

PMD 100 can include an enclosure or housing 102, display 104 for presenting at least visual content and front facing image capture device 106 having lens 108. For the remainder of this discussion, image capture device 106 takes the form of camera 106 capable of capturing both still and moving images for conversion to video. Enclosure 102 can be formed from plastic, metal, composite materials, or other suitable materials, or any combination thereof. Enclosure 102 can protect the interior components of PMD 100 from physical damage, and can also shield the interior components from electromagnetic interference (EMI).

Display 104 can be a liquid crystal display (LCD); a light emitting diode (LED) based display, an organic light emitting diode (OLED) based display, or some other suitable display. In accordance with certain embodiments of the present invention, Display 104 can display a user interface and various other images, such as those captured by front facing camera 106 or logos, avatars, photos, album art, and the like. Display 104 can include a touch screen through which a user can interact with the user interface. The display can also include various function and/or system indicators to provide feedback to a user, such as power status, call status, memory status, or the like. These indicators can be incorporated into the user interface presented by display 104.

Front facing camera 106 can capture video images via lens 108 adapted to collect and focus external light used for forming viewable video images on display 104. While camera 106 and lens 108 are shown to be disposed on a top portion of enclosure 102, it should be appreciated that in other embodiments such elements can be disposed on a bottom, side, or back portions of PMD 100. In other embodiments, camera 106 and lens 108 can be located on a moveable or rotatable element which is coupled to enclosure 102. Still further, camera 106 can be detachable from enclosure 102. Still further, multiple cameras can be included in the same enclosure 102.

As discussed in detail below, PMD 100 can include image acquiring, processing and generating elements adapted to store and execute image calibration schemes used for adjusting various image parameters, such as color response, image white balance (WB), IR filtering (e.g., wavelength cut-off), and so forth. Accordingly, such calibration methods are directed for reducing camera-to-camera variations, such as those resulting from the manufacturing of camera 106 and its components, as well as those resulting from the entire manufacturing process of PMD 100. Consequently, such calibration schemes are adapted to ensure that media players, such as PMD 100, render images consistently and in a manner conforming to the user's liking and expectation. In this manner, media players incorporating digital camera modules, i.e., camera 106 can operate uniformly with minimal variations, thus, preserving and enhancing product performance and product-line uniformity.

FIG. 1B shows rear side 110 of PMD 100. Rear side 110 can include rear facing image capture assembly 112. Rear facing image capture assembly 112 can take the form of rear facing camera 112 having lens 114. Rear facing camera 112 can be used to capture images in a point and shoot manner similar to conventional point and shoot cameras. In this way, PMD 100 can be used in much the same way as the conventional point and shoot camera in so far as capturing a rear facing image.

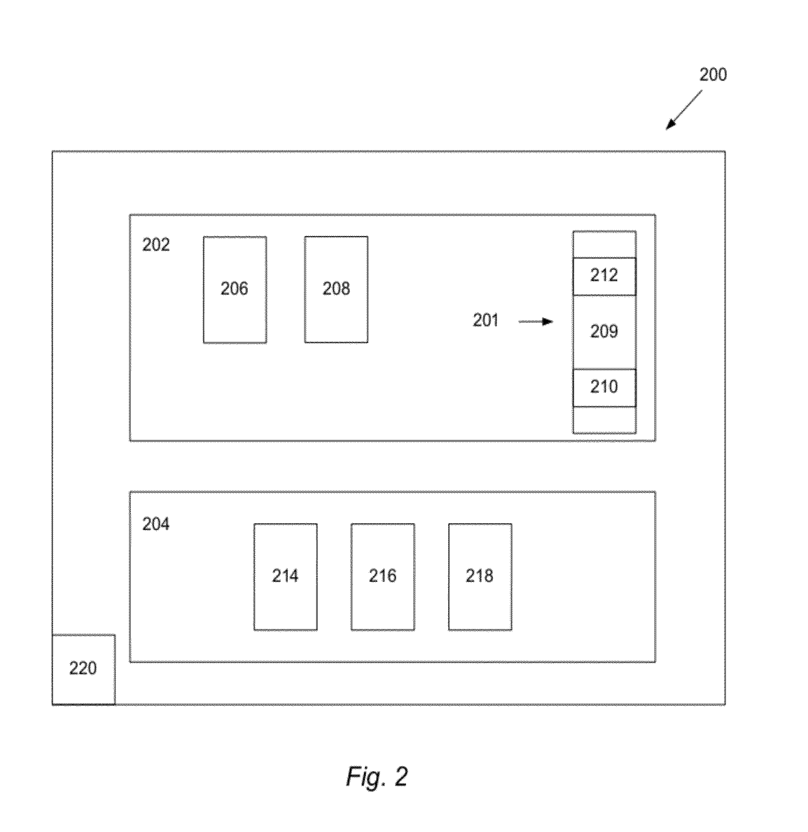

FIG. 2 shows a functional block diagram 200 of PMD 100 including camera system 201 that can include both front facing camera 106 an rear facing camera 112 in accordance with the described embodiments. In particular, FIG. 2 shows that PMD 100 and camera 106 can include various functional elements that cooperate with each other. For example, PMD 100 can include circuit boards 202 and 204 across which the various subcomponents of camera 106 are disposed and/or are coupled thereto. Circuit board 202 can include an erasable programmable read only memory (EPROM) device 206 and facial orientation module 208. As illustrated, circuit board 202 can include camera system 201 with an image sensor 210, and an infrared (IR) filter 212. Those skilled in the art will appreciate that the various components of camera system 201 can be manufactured independently and, thereafter, integrated into camera system 201 via additional manufacturing processes and assembly steps. Circuit board 204 can include processor 214, a memory device 216 and a clock 218. Memory device 216 can include flash, magnetic and/or optical memory devices or a combination thereof.

Camera lens 209 can be a standard-type lens having a certain focal length. Lens 209 can be part of an aperture adapted to gather and focus the acquired light onto the image sensor 210. The image sensor 210, which can include a charge coupled device (CCD), a complementary metal oxide device (CMOS) and/or other silicon based electro-optical sensors, photonic and/or optical fiber based devices, and the like, are adapted to convert the focused light into electrical signals which can be digitally processed to form images. Further, IR filter 212 can be made from an acrylic or Plexiglas-based material for providing wavelength cut-offs in desirable ranges, such as between 630-700 nm. IR filter 212 can also be made from Schott glass for providing high quality and long pass filtering. Camera 106 can incorporate additional optical and electro-optical devices, such as lenses, polarizers, filters, and so forth, adapted to bolster the focusing of the light and enhance its conversion into reliable electrical signals. Facial orientation module 208 can be used to determine an orientation of a user when the user is facing PMD 100 using at least image date captured by camera 106. In some cases, facial orientation module 208 can use in addition to image data captured by camera 106, inertial data provided by an accelerometer or other inertial sensors.

Processor 214 can provide processing capabilities to execute and implement operating system platforms, programs, algorithms and any other functions. For example, the processor 214 can execute on-the-fly algorithms adapted for generating and processing images acquired via camera system 201. Specifically, as discussed below, processor 214 is adapted to calibrate and adjust image parameters, such as color response, white balance (WB), etc., for implementing and augmenting the calibration data provided by the EPROM 206. In so doing, processor 214 is adapted to further reduce module-to-module variations, such as those associated with the manufacturing of camera system 201. Those skilled in the art will appreciate that processor 214 is adapted to execute and support additional routines associated with standard on-the-fly functionalities, such as auto-focus, video play back, image filtering and other firmware related operations. Such functionalities can be invoked and called upon by processor 214 using data files stored by memory 216, having storage capacity for storing audio and/or video files, as well as the above mentioned firmware files. Further, processor 214 can be coupled to external computing or communication devices connectable to the Internet, intranet or other web-based networks for uploading and/or downloading files, such as video and image files, via the port 220.

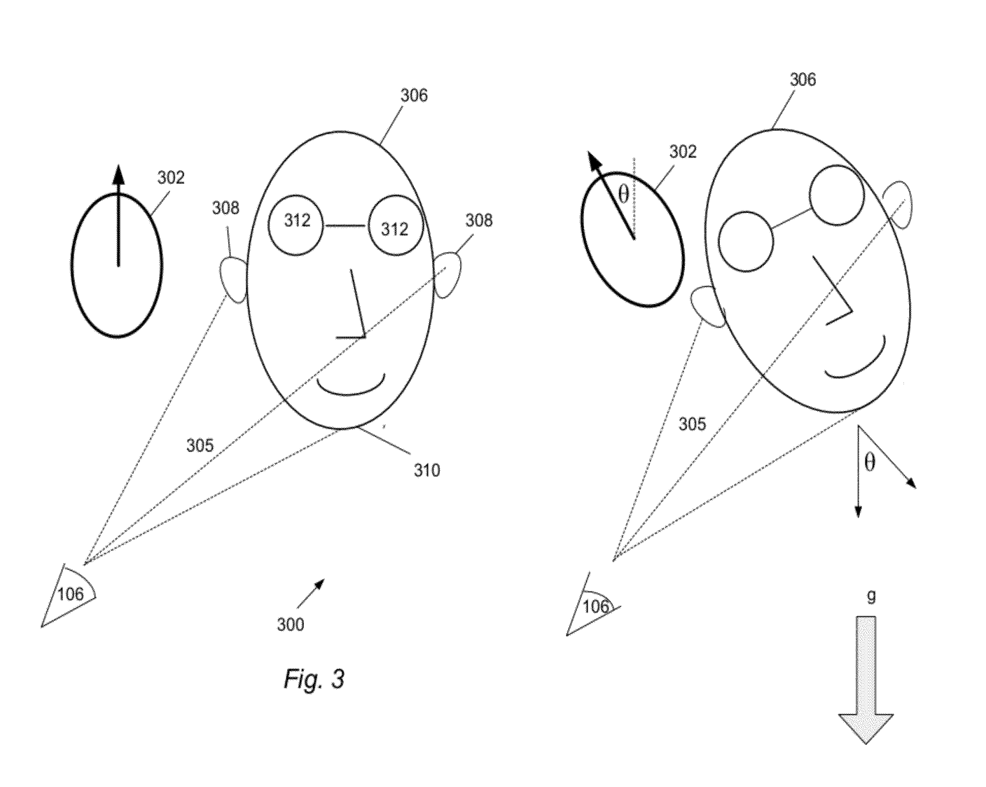

FIG. 3 is a graphical representation 300 for determining a facial orientation vector of a user by PMD 100 in accordance with the described embodiments. Facial orientation vector 302 of user 304 (actually the head of user 304 in the following examples) can be determined based upon image data captured by camera 106. In particular, captured image data 305 can include a number of visual fields (near field, far field, mid field, etc.). However, in order to determine the orientation of user 304, captured image data 305 must include at least some image data that corresponds to human face 306 since only then would user 304 be actually viewing PMD 100. Therefore, in the described embodiment, a determination is made if human face 306 is actually present in any of the visual fields, and more particularly, in the near field or mid field as those are the most likely locations for user 304 to be when using PMD 100. PMD 100 can make this determination by evaluating image data (in the form of pixels) corresponding to human face 306. If the number of pixels corresponding to human face 306 is greater than a threshold value, then PMD 100 can proceed with the determination of facial orientation vector 302. In some embodiments, the threshold value can be as simple as comparing the number of pixels determined to be associated with human face 306 to the number of total pixels corresponding to all visual fields in all image data captured by camera 106 at a particular image capture event the result being a relative number of pixels associated with human face 306. When the relative number of pixels associated with human face 306 is greater than the threshold value, and then PMD 100 can continue processing the image data associated with human face 306. If the threshold value is not exceeded, then a presumption can be made that there is no human face with the visual field of PMD 100 or at least any human faces present cannot be characterized as a user of PMD 100.

Once PMD 100 has determined that human face 306 is within an appropriate distance from PMD 100 and does represent a user of PMD 100, facial orientation module 208 can process image data from camera 106 captured during an image capture event. The image capture event being defined as the actions taken by PMD 100 and camera 106 to capture a single image, the single image for viewing as a snapshot or as a single frame in a video. The processing can include locating facial landmarks such as ears 308, chin 310, eyes 312, and so on. It is desirable to have more than one set of facial landmarks available since it is likely that one or more facial landmarks may not be viewable to camera 106. For example, when user 304 has hair long enough to obscure ears 308, or when user 304 has a beard that hides chin 310 and so on. In this way, facial orientation module 208 can process captured image data 305 from camera 106 and determine facial orientation vector 302. In particular, facial orientation vector 302 can be based upon angular deviation θ from direction of gravity “g” representing “down”. For example, when user 304 is reclining, then facial orientation vector 302 can take on a value θ of about π/2, or 90°. Therefore in most situations, facial orientation vector 302 can range from about ±π/2 (indicating right declination or left declination). However, it is not out of the question that facial orientation vector 302 can take on value θ of about π when user 304 is upside down. Therefore in the most generalized situation, facial orientation vector 302 can range from −π≦θ≦π.

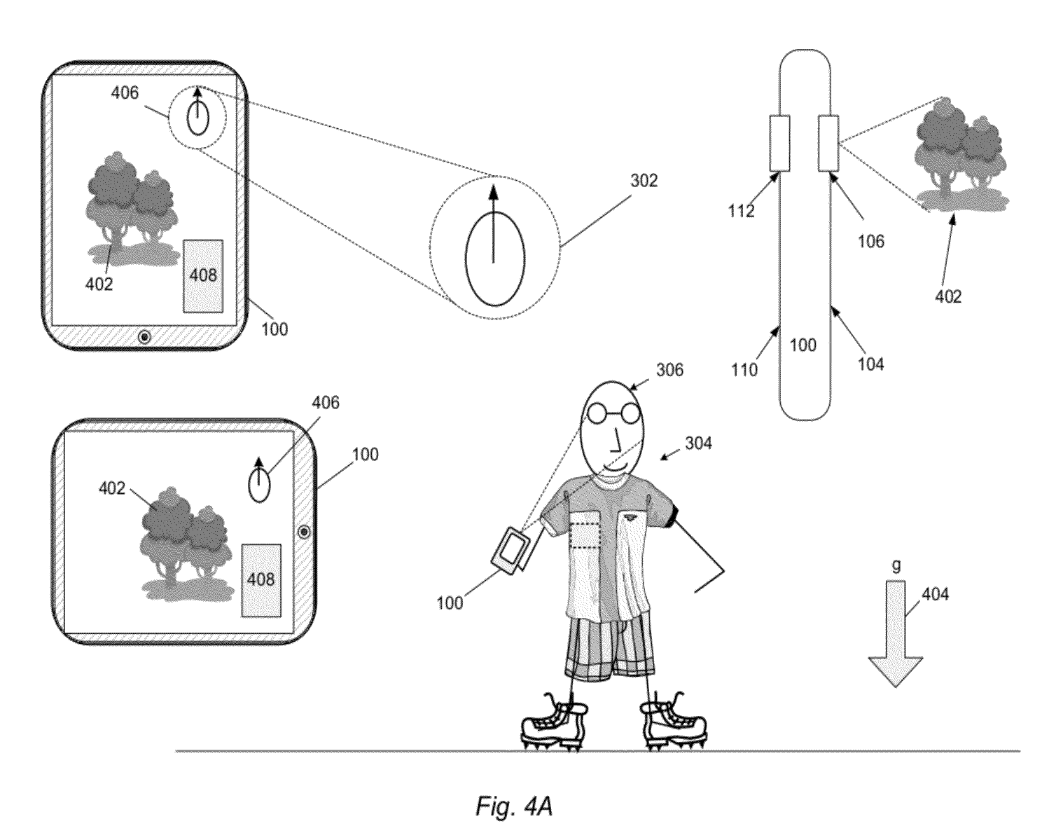

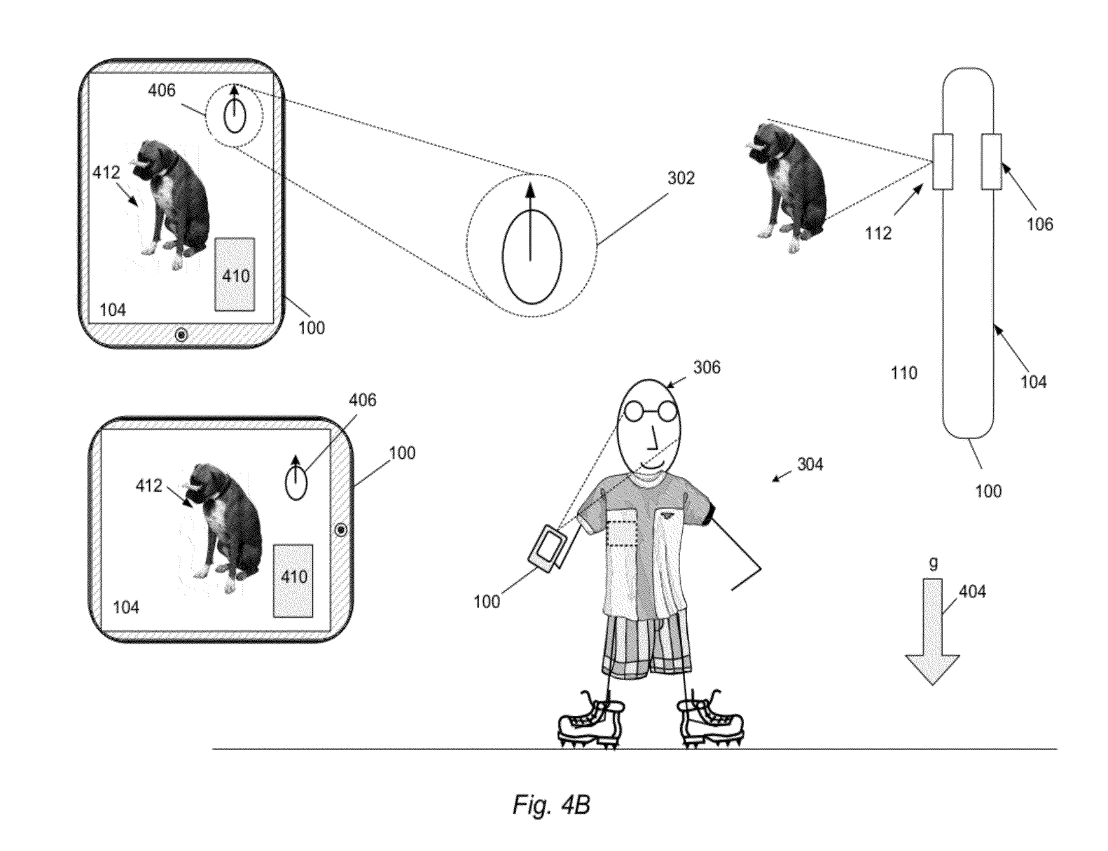

FIGS. 4A and 4B, 5A and 5B and 6-8 graphically illustrate the operation of PMD 100 in a facial orientation mode in accordance with the described embodiments. In facial orientation mode, PMD 100 can periodically sense an orientation of a user's face and adjust the operation of the PMD 100 accordingly. FIGS. 4A and 4B, 5A and 5B and 6-8 show a specific aspects of the facial orientation mode whereby orientation detecting module 208 in PMD 100 can determine an orientation of the user's face using image data periodically captured by an onboard front facing camera assembly. The orientation detection module can use various facial landmarks (eyes, ears, chin, nose, etc.) to assist in determining the facial orientation of the user. More than one facial landmark is generally used as there may be instances where one or two usual landmarks are unviewable (such as the case of the user having hair long enough to cover their ears). The orientation detecting module can then forward the current orientation data to a processor in PMD 100. The processor can, in turn, use the orientation data to provide a facial orientation vector (or equivalent representation). The facial orientation vector can, in turn, be used to modify current operations of PMD 100. For example, a current facial orientation vector can be used by the processor to cause PMD 100 adjust the orientation of visual content presented on display 104. Any changes in the orientation of the user's head can be reflected in an updated facial orientation vector that can be used to update the presented visual content. In this way, regardless of the orientation of the user's head, the user can comfortably and easily view the presented visual content.

FIG. 4A shows user 304 standing upright holding PMD 100 with side view of PMD 100 highlighting front facing camera 106 and rear facing camera 112. User 304 can hold PMD 100 in one hand, point either front facing camera 106 and rear facing camera 112 to capture an image and viewing visual content 402 (which in this case happens to be trees 402) presented on display 104. Arrow 404 provides a point of reference indicating the direction of gravity g, or more commonly, “down”. It should also be noted that since user 304 will generally view visual content 402 having an orientation aligned with facial orientation vector 302, visual content 402 is shown as would be viewed by an upright observer, not user 304. In facial orientation mode, camera 106 can be instructed to periodically capture image data 305. Image date 305 can include various visual components such as a background image, a foreground image and so forth. However, since user 306 is presumed to be currently viewing visual content 402 on PMD 100, it is reasonable that a substantial portion of image data 305 captured by camera 106 includes at least some image data corresponding to human face 306 located in at least the near field and/or the mid field of view. In this way, at least a portion of image data 305 can be processed by orientation detection module 208 to determine the orientation of human face 306 of user 304 expressed by processor as facial orientation vector 302. It should be noted that since facial orientation vector 302 indicates a relative orientation of human face 306 with respect to presented visual content 402 it is therefore independent of the direction of gravity “g” represented by arrow 404. Once facial orientation vector 302 has been updated, PMD 100 can cause visual content presented by display 104 to align with updated facial orientation vector 302. For example, regardless whether PMD 100 is held in landscape mode or portrait mode, visual content 402 can be presented in such a way as to be aligned with facial orientation vector 302. In some embodiments, icon 406 can be presented along with visual content 402 on display 104 indicating a current status of facial orientation vector 302. The presentation of icon 406 can be optional at the discretion of user 304.

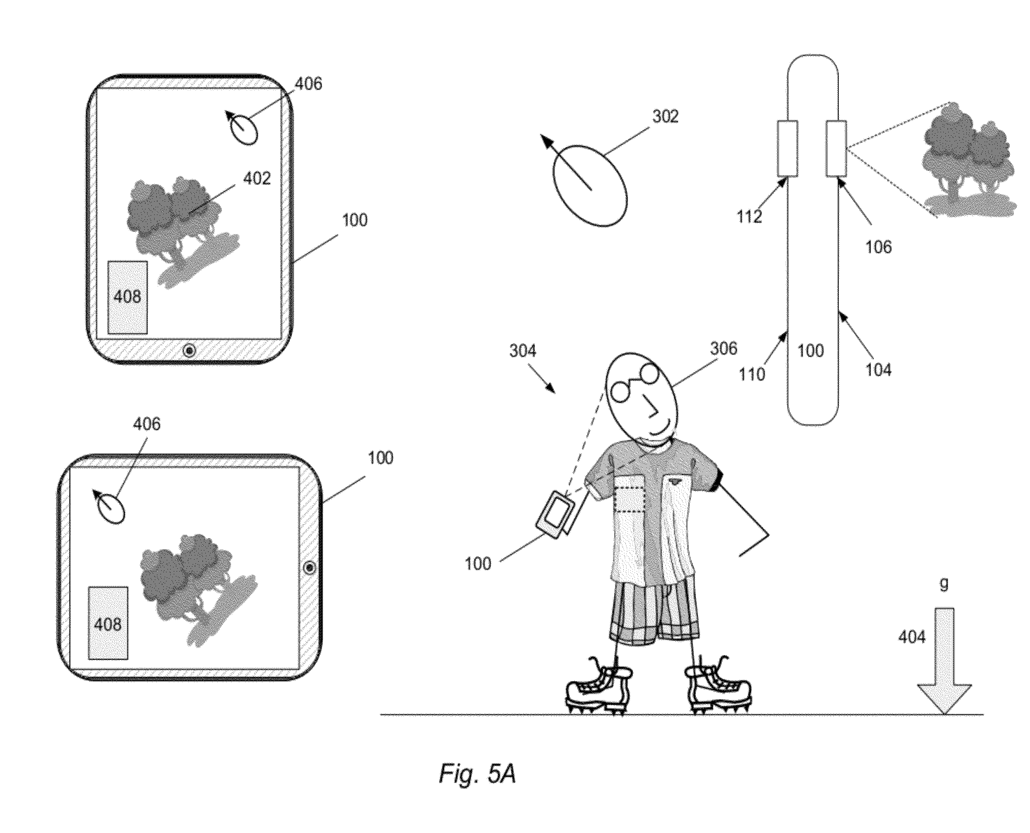

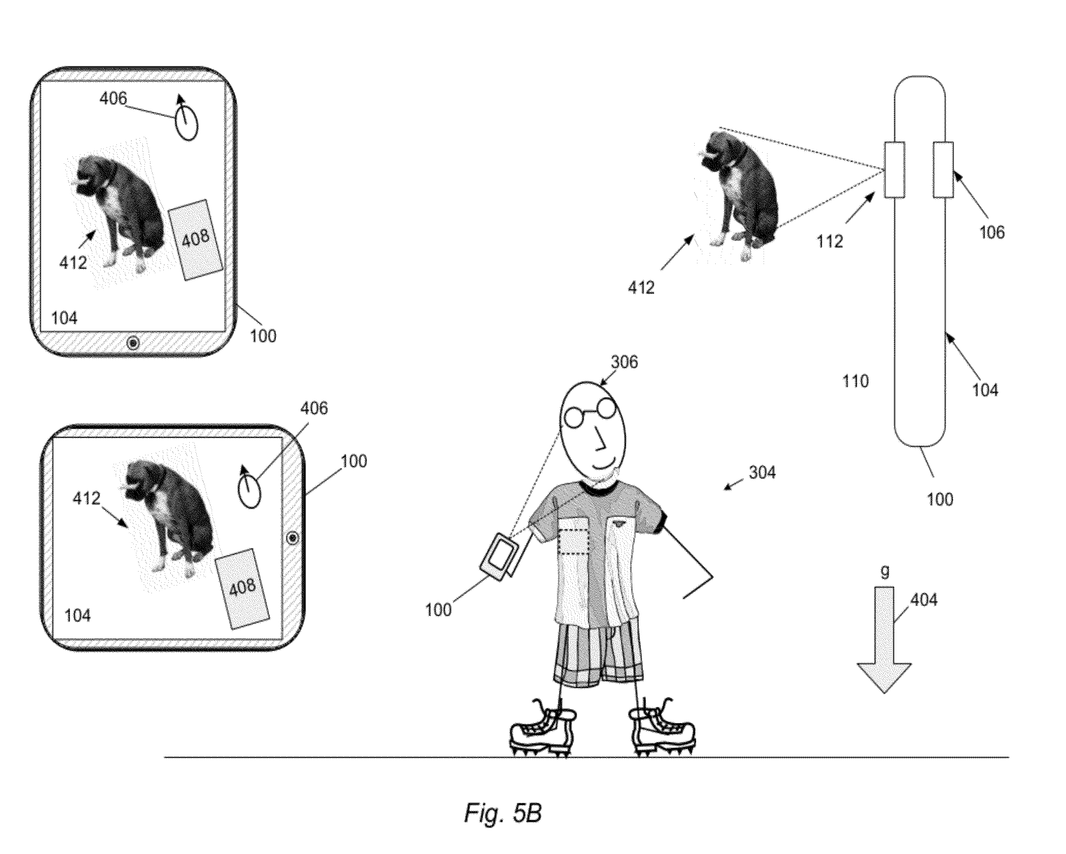

As shown in FIG. 4A, visual content 402 can be presented by display 104 in accordance with facial orientation vector 406. In some cases, visual content 408 can also be displayed that can be independent of visual content 402. Visual content 408 can take the form of, for example, a graphical user interface that can assist user 306 by providing a convenient tool for both providing and receiving information to PMD 100. In some embodiment visual content 408 can be aligned with facial orientation vector 302, however, in other embodiments, visual content can be aligned with the direction of gravity (arrow 404) regardless the status of facial orientation vector 302. In this way, as shown in FIG. 5A, visual content 402 can presented oriented in alignment with facial orientation vector 302 concurrently with visual content 408 presented in a different alignment, such as being aligned with the direction of gravity represented by arrow 404.

FIG. 4B shows PMD 100 rear facing camera 112 capturing image 410 (in this case a dog) and presented by display 104 as visual content 412 in accordance the described embodiments. In some situations, visual content 412 can be presented having an orientation aligned with facial orientation vector 302. In other embodiments, however, as shown in FIG. 5B, visual content 412 can be presented in an orientation aligned with facial orientation vector 302. It should be noted, however, that in some embodiments, visual content 408 (that can take the form of the graphical user interface) can also be presented by display 104 aligned with facial orientation vector 302. In this way, the particular orientation of visual elements presented by display 104 can be dynamic in nature by which it is meant that in some cases a particular visual element is aligned with facial orientation vector 302, in other situations, the visual element can be aligned with the direction of gravity represented by arrow 404. In still other situations, the visual element can be presented having an alignment pre-selected by user 306 and fixed, for example, to a particular reference orientation.

It should also be noted that in some embodiments, PMD 100 can process the images captured by front facing camera 106 and/or rear facing camera 112 in a pre-determined manner. For example, in some embodiments, a preferred orientation can be provided to PMD 100 in a processor incorporated into PMD 100 can perform image processing on the captured image data based upon the preferred orientation only. In this way, captured images (in the form of a snap shot, video etc.) can be processed in a manner consistent with the preferred orientation regardless of the real time orientation of PMD 100 when the image was captured.

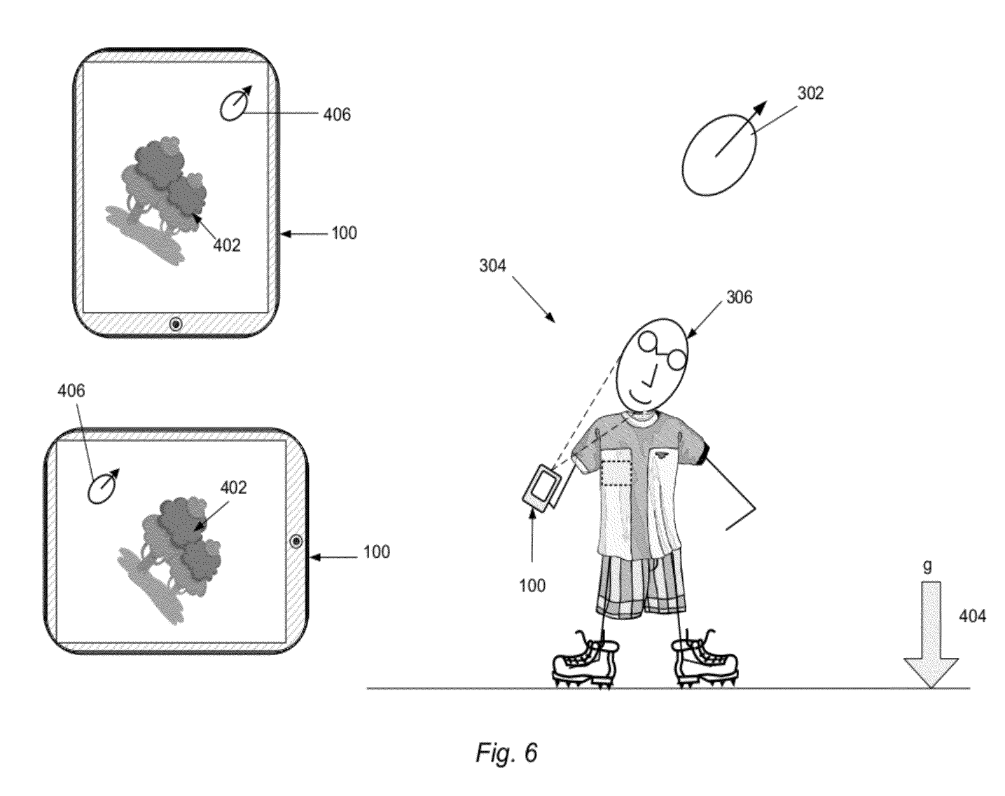

As shown in FIGS. 5A, 5B and 6, when user 304 causes face 306 to tilt in one direction or another, visual content 402 also tilts in real time in accordance with the tilting movements of face 306. For example, when user 304 tilts face 306 to the left (as shown in FIG. 5), visual content 402 presented on display 104 also tilts to the left in accordance with the updated facial orientation vector 302. FIG. 6 shows user 304 tilting face 306 to the right in which PMD 100 responds by moving visual content 402 presented on display 104 again in accordance with facial orientation vector 302.

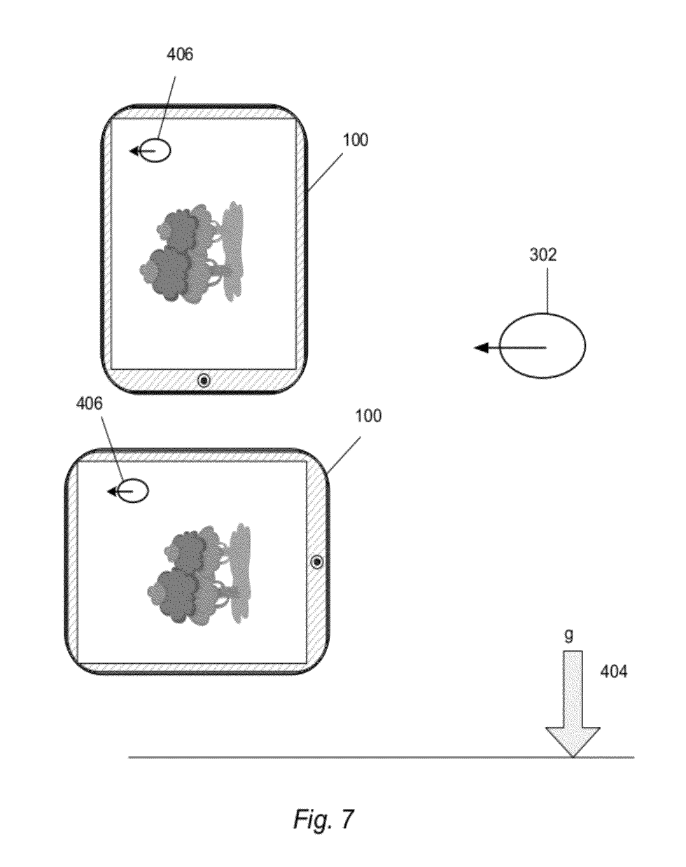

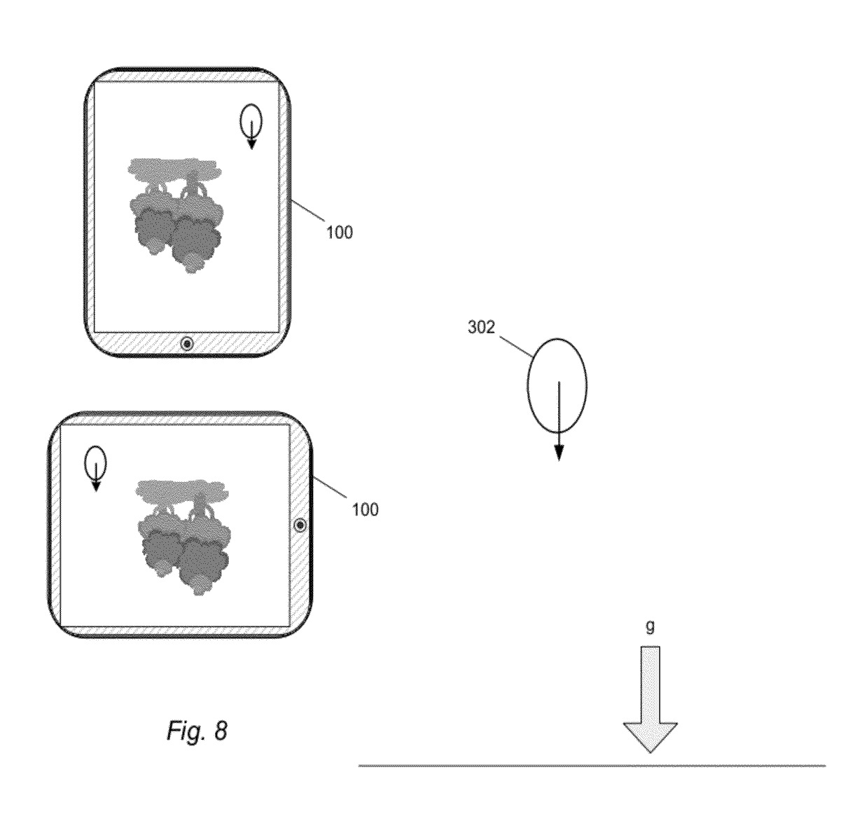

FIG. 7 shows facial orientation vector 302 corresponding to user 304 in a reclining position in which facial orientation vector 302 is approximately ninety degrees from vertical (represented by direction of gravity “g” vector). In this way, when user 304 is reclining on a sofa, bed, and so forth, PMD 100 can react by shifting the orientation of presented visual content 402 accordingly. It should be noted that when user 304 is reclining in a low or no light environment, camera 106 can rely upon IR image data. The IR image data can be based upon thermal images that can be used by processor 214 to ascertain facial orientation vector 302. Still further, FIG. 8 shows how even when user 304 is upside down, PMD 100 can present visual content 402 in accordance with the current facial orientation of user 302 (which in this case is upside down).

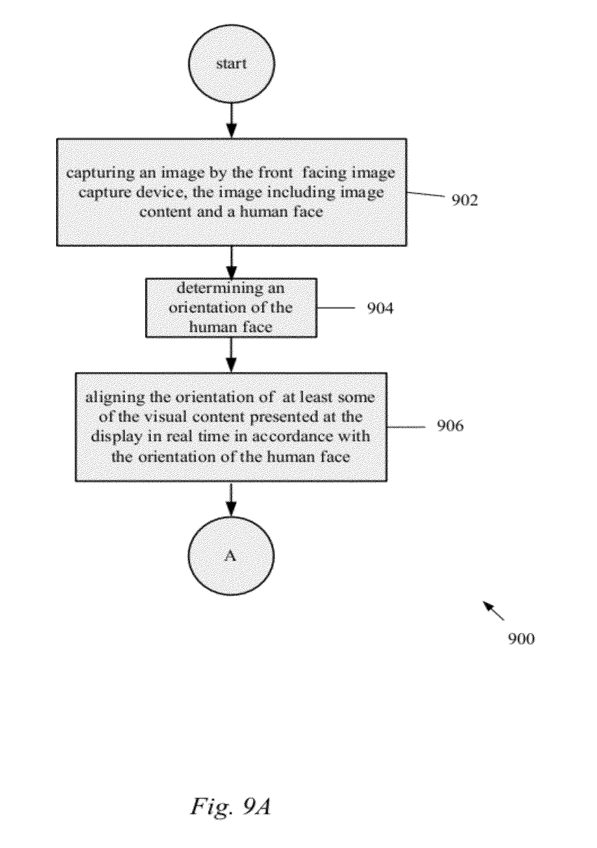

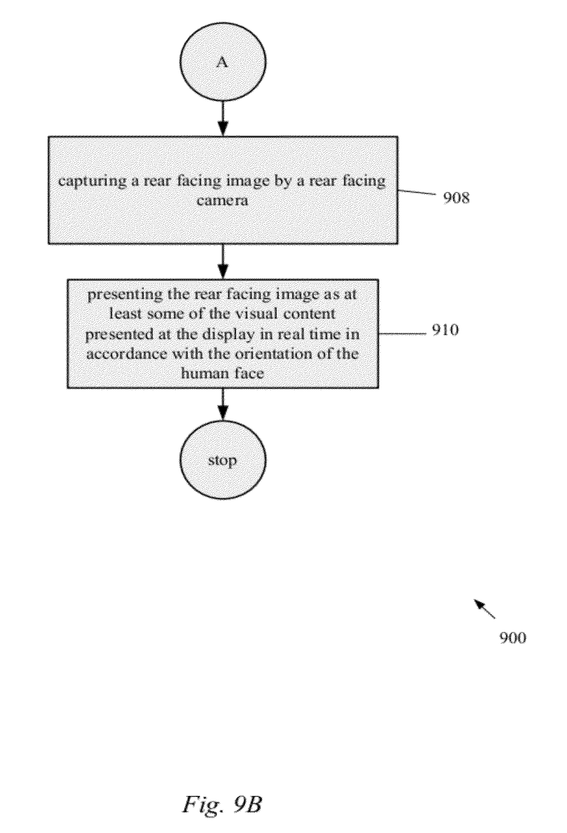

In addition to or in conjunction with facial orientation mode, PMD 100 can operate in a manner in which image data 305 captured by camera 100 can be used to modify a current operating state of PMD 100. For example, FIG. 9A shows a flowchart detailing process 900 in accordance with the described embodiments. Process 900 can be carried out by providing an electronic device having at least a front facing image capture device. The front facing image capture device can take many forms one of which is a camera operable to capture image data. In some cases the image data can include IR image data as well as image data in the visible range. In any case, the front facing image capture device can capture image data at 902. The image data can be captured periodically when the image capture device operates in the background, depending of course on available power resources. The captured image data can then be processed. The processing of the image data can depend upon a particular operating mode in which the electronic device is operating. For example, at 904, the processing can include determining a facial orientation of a human face associated with the captured image. Once the image data has been processed, the current operating state of the electronic device can be updated in accordance with the processed image data. For example, in the case where the electronic device is in facial orientation mode, the processed image data can include in part a facial orientation vector. When the electronic device includes a display on which is presented visual content, the facial orientation vector can be used to modify the presentation of the visual content by, for example, changing the orientation of the displayed visual fields (i.e., displayed in portrait mode, landscape mode or somewhere in-between). For example, at 906, the orientation of at least some of the visual content presented at the display in real time in accordance with the orientation of the human face.

In some embodiments, the PMD can include in place or in addition to the front facing image capture device, a rear image capture device that can take the form of a rear facing camera. The rear facing camera can capture rear facing images at 908 (FIG. 9B). The rear facing images can be presented by the display as at least some of the visual content presented at the display in real time in accordance with the orientation of the human face.

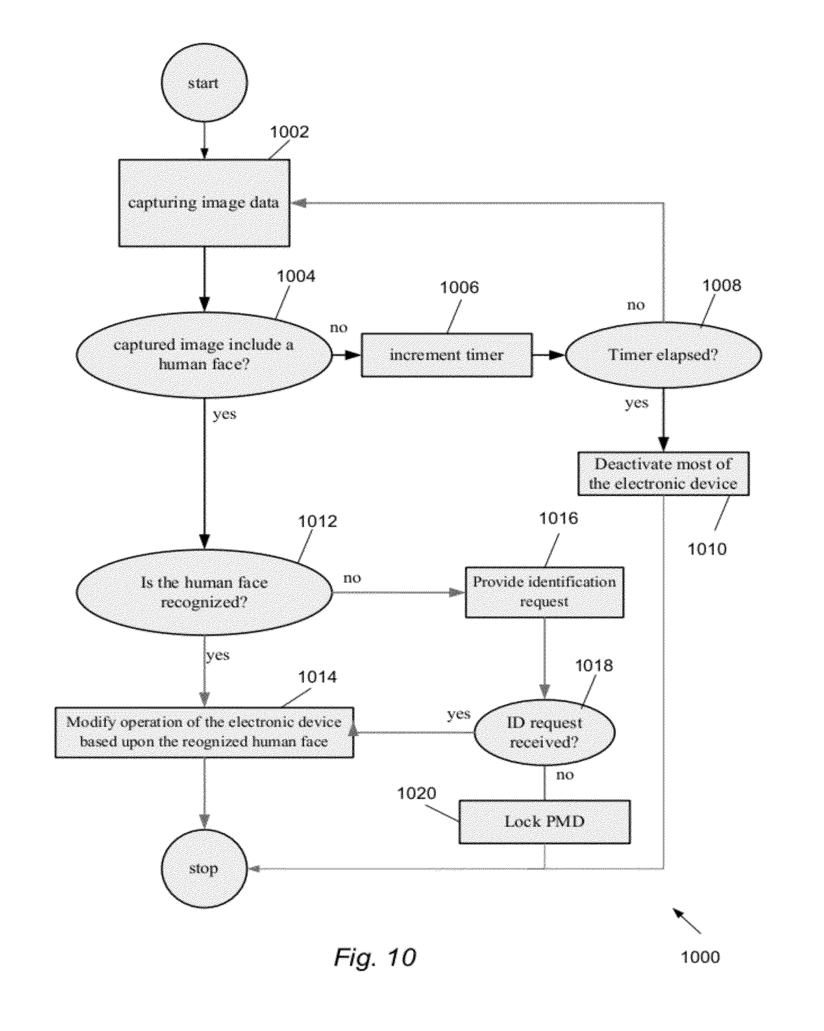

FIG. 10 shows a flowchart detailing process 1000 in accordance with the described embodiments. Process 1000 can be used to process image data captured by an image capture device included in an electronic device. The electronic device can take the form of a personal media device, or PMD, having a display for presenting visual content. Process 1000 can begin at 1002 by receiving the captured image data. The captured image data can include a number of image components. The image components can include, for example, a foreground of images, a background of images and so forth. In some cases, the image capture device can be set in video capture mode in which a plurality of correlated still images (referred to as frames or video frames) can be captured and stored for subsequent video processing. In any case, at 1004, a determination is made if there at least a portion of the captured image data includes an image of at least a portion of a human face. The determination of the inclusion of the human face in the captured image data can be based upon a facial recognition program that utilizes specific facial landmarks to establish the presence (or absence) of a human face in the visual field of the image capture device.

It should be noted that it is contemplated that process 1000 is operable when the PMD is being actively used. Therefore, as part of step 1004, if at least a portion of the human face is determined to be present in the captured image data, in some embodiments, a threshold value can be applied to determine if the human face is actually viewing the visual content presented by the display. In one embodiment, the threshold value can be represented as the number of display elements (referred to as pixels) associated with the human face. Since a bone fide user is expected to occupy a substantial portion of the available image space, the human face should represent a substantial part of the captured image data. In this way, if the threshold value is not exceeded, then it is reasonable to presume that there is no user actively viewing the presented visual content and that the detected human face is likely not a user but more likely a casual observer or passerby. Therefore, if at 1004 it is determined that there is no human face included in the captured image data, then a timer is incremented at 1006 and at 1008 a determination is made if the timer has elapsed. In this way, when no human face corresponding to the user has been detected for at least the elapsed period of time, then it can be reasonably presumed that the PMD is not being used as there is a good chance that the presented visual content is not being actively viewed. In this case, when the time has elapsed at 1008, most of the operational components of the PMD can be de-activated in order to conserve power or operational lifetime of the component at 1010 even when the PMD is receiving external power. It should be noted that the image capture device can remain operational for subsequent processing. On the other hand, if the timer has not elapsed, then control can be passed back to 1002 where additional image data can be captured for further processing.

Returning back to 1004, when it has been determined that at least a portion of the human face has been detected in the visual field of the image capture device (i.e., the number of pixels associated with the human face is greater than the threshold value), then at 1012 a determination is made if the detected human face is a recognized human face or an unrecognized human face. By recognized it is meant that the detected human face has at least a number of facial characteristics that taken together match or at least correlate to facial characteristics stored in a local database corresponding to a known individual. If the detected human face is recognized, then at 1014, an operation of the PMD can be modified based upon the recognized human face. The modification can include executing a pre-defined set of operations such as opening email, opening text messages, and so forth.

If, however, the detected human face is not recognized, then at 1016 an identification request can be generated. The identification request can be as simple as posting a notice to enter a name, password, pass phrase, and so forth. If at 1018 it is determined that a proper ID has not been received, then the PMD can be disabled or at least locked at 1020. The locking or disabling can provide a layer of security by providing secure facial recognition procedure. However, if the proper ID has been received then control is passed to 1014 for additional processing.

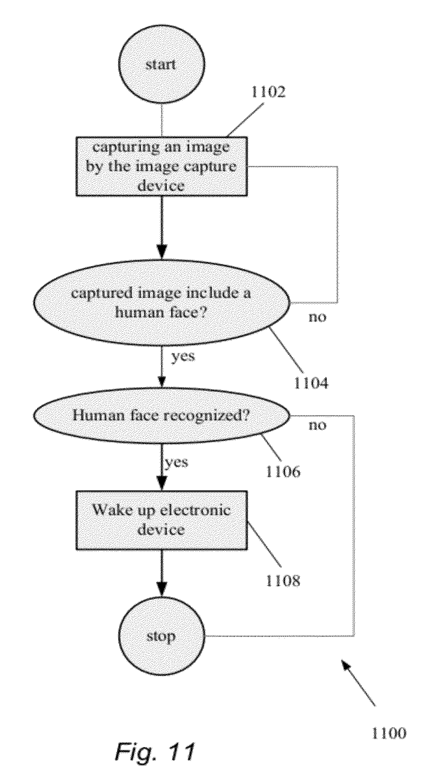

FIG. 11 shows a flowchart detailing process 1100 in accordance with the described embodiments. Process 1100 can be used to “wake up” a sleeping PMD simply by the user approaching the sleeping PMD and presenting him/herself to the image capture device. Accordingly, process 1100 can begin at 1102 by capturing image data. It should be noted that even while sleeping, the image capture device can be set to periodically capture and at least minimally process the captured image data to determine if a human face has been detected at 1104. In this way, the image capture device can continue to acquire image data until at 1104 it is determined that a human face has been detected in the captured image data. Once the human face has been detected, then at 1106, a determination is made if the detected human face is recognized or not, and if recognized then at 1108, instructions can be generated to wake up the PMD.

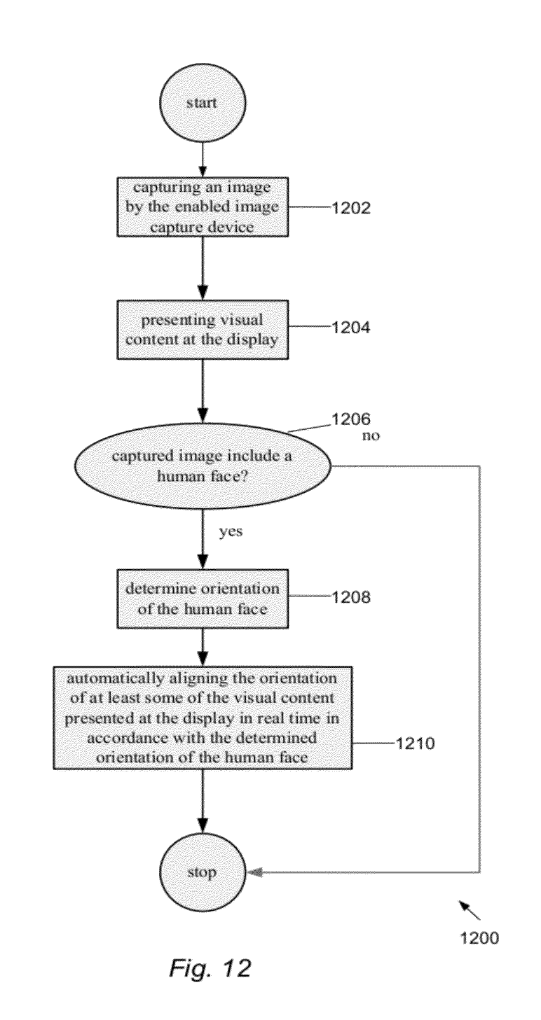

FIG. 12 shows a flowchart detailing process 1200 in accordance with the described embodiments. Process 1200 can be performed by a personal media device having a front facing image capture device such as a camera and a front facing display device configured to display visual content at an orientation. Process 1200 can begin at 1202 by capturing image data at the image capture device while visual content is being presented at the front facing display at 1204. Next at 1206, a determination is made whether or not at least a minimum amount of the captured image data corresponds to a human face. In the described embodiment, the minimum amount of capture image data can correspond to a number of image elements such as pixels corresponding to the human face compared to a total number of captured image pixels. Only when the number of human face pixels is greater than the minimum, or threshold value, is the human face considered to be present. When the human face is determined to be present, then at 1108, a facial orientation vector of the human face is generated. At 1210, the facial orientation vector is used by a processor in the PMD to automatically align the orientation of the presented visual content with the facial orientation vector. In one embodiment, an icon representing the facial orientation vector can be presented at the display in conjunction with the displayed content.

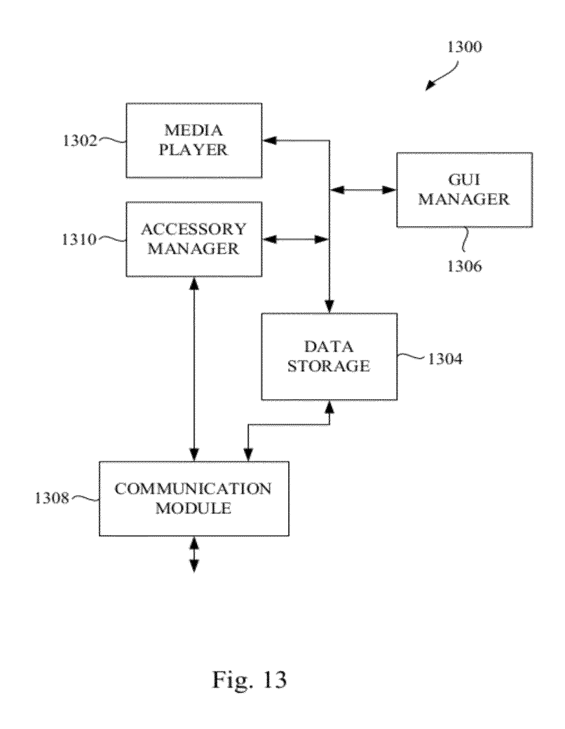

FIG. 13 is a block diagram of an arrangement 1300 of functional modules utilized by a portable media device. The portable media device can, for example, be portable media device 100 illustrated in FIG. 1. The arrangement 1300 includes a media player 1302 that is able to output media for a user of the portable media device but also store and retrieve data with respect to data storage 1304. The arrangement 1300 also includes a graphical user interface (GUI) manager 1306. The GUI manager 1306 operates to control information being provided to and displayed on a display device. The arrangement 1300 also includes a communication module 1308 that facilitates communication between the portable media device and an accessory device. Still further, the arrangement 1300 includes an accessory manager 1310 that operates to authenticate and acquire data from an accessory device that may be coupled to the portable media device.

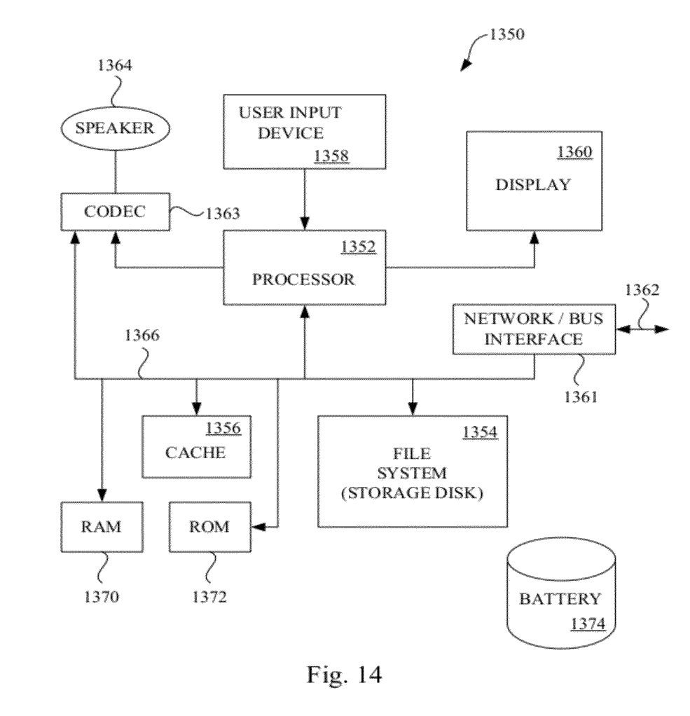

FIG. 14 is a block diagram of a media player 1350 suitable for use with the described embodiments. The media player 1350 illustrates circuitry of a representative portable media device. The media player 1350 includes a processor 1352 that pertains to a microprocessor or controller for controlling the overall operation of the media player 1350. The media player 1350 stores media data pertaining to media items in a file system 1354 and a cache 1356. The file system 1354 is, typically, a storage disk or a plurality of disks. The file system 1354 typically provides high capacity storage capability for the media player 1350. However, since the access time to the file system 1354 is relatively slow, the media player 1350 can also include a cache 1356. The cache 1356 is, for example, Random-Access Memory (RAM) provided by semiconductor memory. The relative access time to the cache 1356 is substantially shorter than for the file system 1354. However, the cache 1356 does not have the large storage capacity of the file system 1354. Further, the file system 1354, when active, consumes more power than does the cache 1356. The power consumption is often a concern when the media player 1350 is a portable media device that is powered by a battery 1374. The media player 1350 can also include a RAM 1370 and a Read-Only Memory (ROM) 1372. The ROM 1372 can store programs, utilities or processes to be executed in a non-volatile manner. The RAM 1370 provides volatile data storage, such as for the cache 1356.

The media player 1350 also includes a user input device 1358 that allows a user of the media player 1350 to interact with the media player 1350. For example, the user input device 1358 can take a variety of forms, such as a button, keypad, dial, touch screen, audio input interface, video/image capture input interface, input in the form of sensor data, etc. Still further, the media player 1350 includes a display 1360 (screen display) that can be controlled by the processor 1352 to display information to the user. A data bus 1366 can facilitate data transfer between at least the file system 1354, the cache 1356, the processor 1352, and the CODEC 1363.

In one embodiment, the media player 1350 serves to store a plurality of media items (e.g., songs, podcasts, etc.) in the file system 1354. When a user desires to have the media player play a particular media item, a list of available media items is displayed on the display 1360. Then, using the user input device 1358, a user can select one of the available media items. The processor 1352, upon receiving a selection of a particular media item, supplies the media data (e.g., audio file) for the particular media item to a coder/decoder (CODEC) 1363. The CODEC 1363 then produces analog output signals for a speaker 1364. The speaker 1364 can be a speaker internal to the media player 1350 or external to the media player 1350. For example, headphones or earphones that connect to the media player 1350 would be considered an external speaker.

The media player 1350 also includes a network/bus interface 1361 that couples to a data link 1362. The data link 1362 allows the media player 1350 to couple to a host computer or to accessory devices. The data link 1362 can be provided over a wired connection or a wireless connection. In the case of a wireless connection, the network/bus interface 1361 can include a wireless transceiver. The media items (media assets) can pertain to one or more different types of media content. In one embodiment, the media items are audio tracks (e.g., songs, audio books, and podcasts). In another embodiment, the media items are images (e.g., photos). However, in other embodiments, the media items can be any combination of audio, graphical or visual content.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A method for displaying visual content by an electronic device having a plurality of operational components at least one of which is a front facing image capture device and at least another is a front facing display device arranged to display visual content, the method comprising:
capturing an image by the front facing image capture device, the image including image content;
determining an orientation of a human face associated with at least some of the captured image content; and
aligning the orientation of at least some of the visual content presented at the display in real time in accordance with the orientation of the human face.

2. The method as recited in claim 1, wherein the electronic device further includes a rear facing camera arranged to capture a rear facing image, the method further comprising:
presenting the rear facing image as at least some of the visual content presented at the display in real time in accordance with the orientation of the human face.

3. The method as recited in claim 1, further comprising:
presenting at least some of the visual content presented at the display in real time in accordance with the direction of gravity.

4. The method as recited in claim 1, wherein the at least some of the visual content presented at the display aligned in real time with the orientation of the human face is a graphical user interface.

5. The method as recited in claim 2, further comprising:
receiving a processing orientation; and
processing at least some the rear facing captured image in accordance with the processing orientation.

6. The method as recited in claim 1, wherein the electronic device is a personal media device.

7. A personal media device, comprising:
a front facing display configured to present visual content;
a front facing camera, the front facing camera configured to capture image data;
a facial orientation module, the facial orientation module arranged to generate a facial orientation vector based in part upon the captured image data, the facial orientation vector corresponding to a facial orientation of a current user viewing the front facing display;
a rear facing image capture device arranged to capture a rear facing image; and
a processor coupled to the front facing display, the front facing camera, and the rear facing camera, the processor configured to display in real time at least some of the visual content presented by the display in accordance with the orientation of the human face.

8. The personal media device as recited in claim 7, wherein the processor causes the display to present at least some of the rear facing image as at least some of the video content with the orientation of the human face.

9. The personal media device as recited in claim 7, wherein at least some of the visual content is presented by the display in an orientation aligned with the direction of gravity.

10. The personal media device as recited in claim 7, further comprising:
receiving an indication of a preferred orientation; and
processing the rear image content in accordance with the preferred orientation.

11. The personal media device as recited in claim 7, wherein the facial orientation module generates the facial orientation vector by,
receiving at least some of the captured image data,
determining if at least some of the captured image data corresponds to a human face,
determining if the human face is a user of the personal media device,
identifying facial landmarks of the human face of the user; and
using the identified facial landmarks to generate the facial orientation vector.

12. Non-transitory computer readable medium for storing computer code executed by a processor in a personal media device having at least a front facing image capture device and a front facing display device arranged to display visual content for modifying a current operational state of the personal media player, comprising:
computer code for capturing an image by the image capture device, the image including image content; and
computer code for modifying the current operational state of the electronic device in accordance with captured image content.

13. The computer readable medium as recited in claim 12, further comprising:
computer code for determining if the captured image content includes a human face.

14. The computer readable medium as recited in claim 13, wherein when the captured image includes the human face, the computer code for modifying the current operational state comprises:
computer code for determining an orientation of the human face; and
computer code for automatically aligning the orientation of the visual content presented at the display in real time in accordance with the determined orientation of the human face.

15. The computer readable medium as recited in claim 14, wherein the image capturing is periodically performed in the background.

16. The computer readable medium as recited in claim 15 further comprising:
computer code for repeating the image capturing for at least a preset duration of time when the captured image does not include the human face;
computer code for de-activating most of the electronic device after the duration of time has elapsed, otherwise;
computer code for determining an identity of the human face; and
modifying the operational state when the human face is recognized.

17. The computer readable medium as recited in claim 16, wherein when the human face is not recognized, the computer readable medium further comprising:
computer code for providing an identification request to identify the unrecognized human face.

18. A method, comprising:
capturing image data by a front facing image capture device associated with a personal media device, the personal media device having a front facing display configured for displaying visual content at an orientation;
presenting the visual content at the display device at the orientation;
determining if a human face is included in the captured image data;
determining a facial orientation vector associated with the human face; and
using the facial orientation vector to modify the presenting of the visual content by the display.

19. The method as recited in claim 18, further comprising:
using the facial orientation vector to modify the presenting of the visual content by the display by aligning the orientation of the presented visual content to the facial orientation vector.

20. The method as recited in claim 18, further comprising:
determining if the human face is a recognized human face; and
executing a pre-arranged set of commands corresponding to the recognized human face.

21. The method as recited in claim 19, wherein the pre-arranged set of commands includes awakening the personal media device when the personal media device is in a sleep mode.
